(19) United States
(12) Patent Application Publication
(10) Pub. No.: US 2005/0088319 A1
(43) Pub. Date: Apr. 28, 2005

(54) Traffic signal electric lamp assembly

(76) Inventors: Azmie K. Madanat, Moraga, CA (US); Brian R. Girardot, San Jose, CA (US)

Correspondence Address: Ray K. Shahani, Esq.;ATTORNEY AT LAW, Twin Oaks Office Plaza, 477 Ninth Avenue, Suite 112, San Mateo, CA, 94402-1854, US

(21) Appl. No.: 10/633,092

(22) Filed: Jul. 31, 2003

Related U.S. Application Data
(63) Continuation-in-part of application No. 10/117,880, filed on Apr. 8, 2002, now abandoned.
(63) Continuation-in-part of application No. 29/138,318, filed on Mar. 9, 2001, now Pat. No. D455365.
Application No. 29/138,318 is a continuation-in-part of application No. 29/126,805, filed on Jul. 25, 2000, now Pat. No. D440329.
Application No. 29/138,318 is a continuation-in-part of application No. 29/126,807, filed on Jul. 25, 2000, now Pat. No. D438651.

(51) Int. Cl. G08G 1/095

(52) U.S. Cl. 340/907

(57) ABSTRACT

An enhanced traffic signal which provides greater visibility to the selected indicator light, the traffic signal assembly having a body housing portion, the body housing having at least one front face, a plurality of main colored indicator lights disposed on the at least one front face of the body housing, a controller for changing of the main colored indicator lights as desired, and a peripheral auxiliary lamp portion disposed around the plurality of main colored indicator lights, the outer peripheral auxiliary lamp portion electronically interconnected to the plurality of main colored indicator lights and the controller such illumination of the outer peripheral auxiliary lamp portion is synchronized with the traffic signal.

### CROSS-REFERENCE TO RELATED PATENT APPLICATIONS

This application is related to and is a continuation in part of co-pending U.S. application Ser. No. 10/117,880 filed Apr. 8, 2002, and claims any and all benefit of priority of filing date to which it is entitled therefrom. This application is also related to and is a continuation in part of U.S. Application Serial No. No. 29/138,318 filed Mar. 9, 2001 and issued Apr. 9, 2002 as U.S. D455365, which is also related to and a continuation in part of U.S. Applications Serial No. 29/126,805 issued Mar. 6, 2001 as U.S. D440329 and No. 29/126,807 issued Apr. 10, 2001 as U.S. D438651, both filed Jul. 25, 2000 and claims any and all benefit of priority of filing date to which it is entitled therefrom.

### FIELD OF THE INVENTION

The present invention relates generally to traffic lamps and traffic signal lights used for directing traffic and safety in our communities, and more particularly to an electric light or lamp assembly for traffic signals and traffic lighting assemblies and the like and related method of use thereof in which a conventional or custom traffic signal assembly is adapted to comprise a peripheral lighting electric lamp portion having a corresponding shape size and capable of turning a corresponding color as the color being indicated on the traffic light, the resulting enhanced traffic signal having enhanced visibility from the front as well as all sides.

### BACKGROUND OF THE INVENTION

Traffic lights and traffic signals have been in use since throughout most of the last century. Today, their use is prevalent, interspersed with stop signs, in residential districts, business districts, and on and near highways and freeways. As the use of stop lights and traffic lights has grown, so too has traffic volume and speed of vehicles traveling on the roads these days. Traffic lights and traffic signals are typically suspended or otherwise mounted at a road or street intersection or crossing above the intersecting roads or streets where it can be seen by oncoming traffic from any specific direction.

Unfortunately, given the high amount of signage and advertising found on the streets and in our communities, particularly with neon or LED lights and particularly at night time, traffic signals which are only used for safety, often become less visible or less discernible in the line of sight of a driver or pedestrian. Given the tremendous increase in number and type of distractions on the road, ranging from other traffic of a vehicular and pedestrian nature to parked vehicles, signage, buildings, etc., the standard traffic signal has become less useful in maintaining safety.

### OBJECTS AND ADVANTAGES OF THE PRESENT INVENTION

Thus, it is an object and advantage of the present invention to provide an improved traffic signal.

It is a further object and advantage of the present invention to provide such improved traffic signal utilizing the basic and essential functional and design elements of the traditional traffic signal, so as to enhance visibility, anticipation, recognition and compliance therewith.

It is a further object and advantage of the present invention to provide such improved traffic signal in which visibility of the signal is improved, and more particularly, visibility from a forward view or direction as well as visibility from any angle thereto.

It is a further object and advantage of the present invention to provide such improved traffic signal in which an outer, peripheral or otherwise shaped lit lamp is further utilized in conjunction with the main lamps of the traffic signal to enhance visibility thereof.

It is a further object and advantage of the present invention to provide such improved traffic signal in which the outer, peripheral or otherwise shaped lit lamp is designed to be adapted to an existing traffic signal or traffic light, thereby providing a retrofit kit or assembly.

### SUMMARY OF THE INVENTION

In summary, the present invention is an improved traffic signal.

The improved traffic signal of the present invention utilizes the basic and essential functional and design elements of the traditional traffic signal, so as to enhance visibility, anticipation, recognition and compliance therewith. The present invention is recognizable as a familiar regulatory device.

As an aspect of the improved traffic signal of the present invention, visibility of the traffic signal is improved, and more particularly, visibility from a forward view or direction as well as visibility from any angle thereto.

In a preferred embodiment of the improved traffic signal, an outer, peripheral or otherwise shaped lit lamp is further utilized in conjunction with the main lamps of the traffic signal to enhance visibility thereof from the front, from different sides, and from a distance.

In a preferred embodiment of the improved traffic signal, the outer, peripheral or otherwise shaped lit lamp is designed to be adapted to an existing traffic signal or traffic light, thereby providing a retrofit kit or assembly.

Numerous other advantages and features of the present invention will become readily apparent from the following detailed description of the invention and the embodiments thereof, from the claims and from the accompanying drawings.

### BRIEF DESCRIPTION OF THE DRAWINGS

The invention is illustrated below and represented schematically in the following drawings:

FIG. 1A is a representative perspective view of a preferred embodiment of an electric lamp 100 for use with the improved traffic signal of the present invention.

FIG. 1B is a representative front elevation view of a preferred embodiment of the improved traffic signal 102 of the present invention employing the electric lamp 100 as shown in FIG. 1A.

FIG. 1C is a representative side elevation view of a preferred embodiment of the improved traffic signal 102 of the present invention employing the electric lamp 100 as shown in FIG. 1A.

FIG. 2A is a representative perspective view of another preferred embodiment of an electric lamp 200 for use with the improved traffic signal of the present invention.

FIG. 2B is a representative front elevation view of a preferred embodiment of the improved traffic signal 202 of the present invention employing the electric lamp 200 as shown in FIG. 2A.

FIG. 2C is a representative side elevation view of a preferred embodiment of the improved traffic signal 202 of the present invention employing the electric lamp 200 as shown in FIG. 2A.

FIG. 3A is a representative front perspective view of another preferred embodiment of the improved traffic signal 302 of the present invention employing electric lamp 300.

FIG. 3B is a representative front perspective view of a preferred embodiment of the improved traffic signal retrofit assembly 304 of the present invention employing an electric lamp 300.

FIG. 3C is a representative front perspective view of a preferred embodiment of the improved traffic signal retrofit assembly 304 as shown in FIG. 3B employing an alternate electric lamp 300A.

FIG. 3D is a representative front perspective view of a method of use of a preferred embodiment of the improved traffic signal retrofit assembly 304 of the present invention employing an electric lamp 300.

FIG. 3E is a representative front perspective view of another preferred embodiment of the improved traffic signal retrofit assembly 306 of the present invention employing an electric lamp 300.

FIG. 4A is a representative front perspective, exploded view of a preferred embodiment of the improved traffic signal assembly 400 of the present invention employing peripheral auxiliary electric lamp portion 402.

FIG. 4B is a representative front perspective, exploded view of a preferred embodiment of the improved traffic signal assembly 400′ of the present invention employing peripheral auxiliary electric lamp portion 402′.

FIG. 4C is a representative front perspective, exploded view of a preferred embodiment of the improved traffic signal assembly 400′ of the present invention employing peripheral auxiliary electric lamp portion 402′.

FIG. 4D is a representative front perspective, exploded view of a preferred embodiment of the improved traffic signal assembly face plate portion 404″ of the present invention having discrete locations 406″ for employing peripheral auxiliary electric lamp portion 402″ (not shown).

FIG. 4E is a representative front perspective, exploded view of a preferred embodiment of the improved traffic signal assembly 400″ of the present invention employing peripheral auxiliary electric lamp portion 402″.

### DETAILED DESCRIPTION OF THE PREFERRED EMBODIMENTS

It will be understood that in the event parts of different embodiments have similar functions or uses, they may have been given similar or identical reference numerals and descriptions. It will be understood that such duplication of reference numerals is intended solely for efficiency and ease of understanding the present invention, and are not to be construed as limiting in any way, or as implying that the various embodiments themselves are identical.

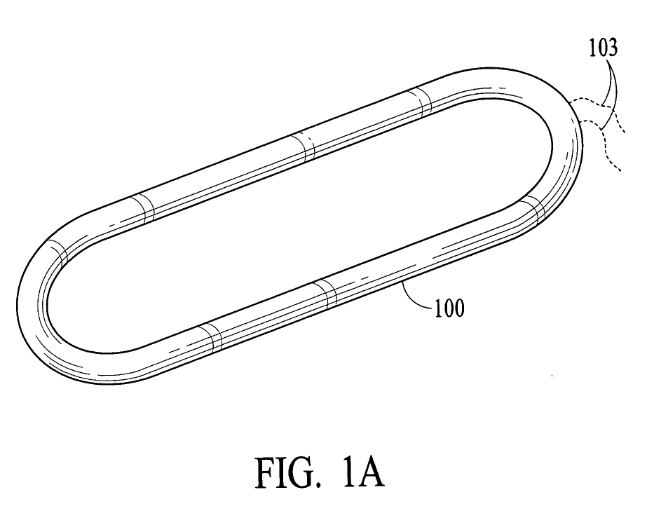

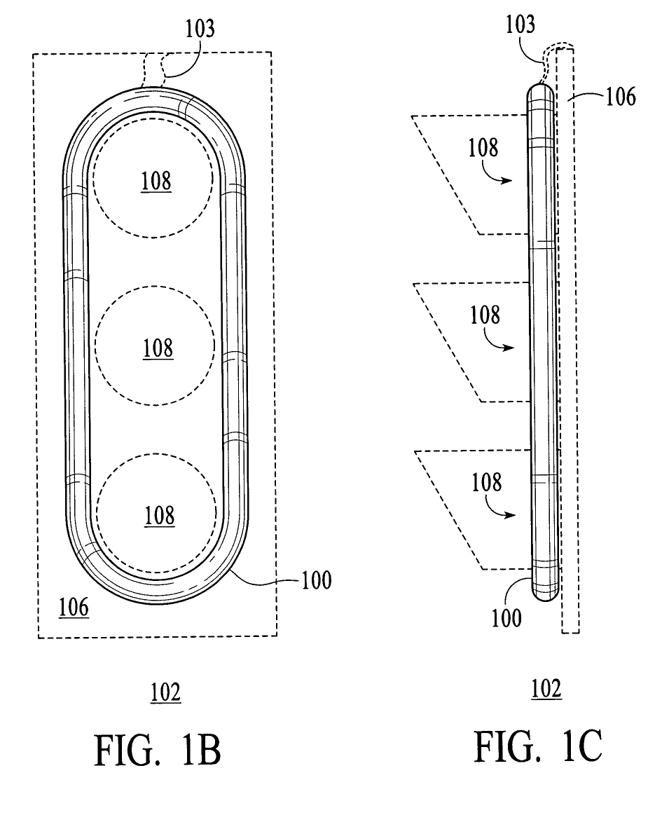

FIG. 1A is a representative perspective view of a preferred embodiment of an electric lamp 100 for use with the improved traffic signal (shown in subsequent drawings) the present invention. A particular design for electric lamp 100 is described more fully in U.S. Application Serial No. 29/126,807 filed Jul. 25, 2000, now U.S. D438651 issued Mar. 6, 2001 entitled ELECTRIC LAMP, which is hereby fully incorporated herein, in its entirety. It will be understood that the oval lamp 100 can be essentially any shape essentially oval or otherwise, having various ratios of length to width, etc. Electrical leads or contacts 104 are shown as extending wires. It will be understood that these electrical contacts can be different sizes and shapes also, including contact points, extending clips, extending prongs, using socket or plug-type adapters directly on the lamp surface, or connected to wiring or a wiring harness.

It will be understood that the electric lamp 100 can be made of any suitable and appropriate lamp or lighting source or means available. These will include, but are not limited to, neon tubing, flexible light rope, fiber optic cables or bundles, imbedded individual or continuous LED or LCD lights, printed lighting circuit. The electrical source is alternating current (AC) or direct current (DC), and be high or low voltage. The light should be constant or pulsed, flashing or sequenced in any particular or desired programmed or programmable sequence. It will be understood that essentially any light source which can be configured into the essentially oval shape shown in FIG. 1A or other shape can be used.

FIG. 1B is a representative front elevation view of a preferred embodiment of the improved traffic signal 102 of the present invention employing the electric lamp 100 as shown in FIG. 1A. As with typical systems, the traffic signal 102 comprises a housing or body portion 106 and three lights 108. The housing or body portion 106 contains electronics, controllers, power source and/or circuit connection to main line source, etc. The electrical leads 104 electrically interconnect the electrical lamp portion 100 to the body or housing 106 of the traffic light system 102 and directly or indirectly to a power source and/or controller. In a preferred embodiment, the electrical leads 104 are connected to a socket or other electrical connection on the body 106 of the traffic light system 102, and subsequently interconnected with the power source and a central processor for the traffic signal. It will be understood that the external, peripheral lamp portion 100 requires a power source and may be three separate bulbs having three separate colors, or it may be a single color and only used to enhance the green, yellow or red of an existing traffic light, or the traffic signal 102 lamp portion 100 can be three different colors and independently controlled.

FIG. 1C is a representative side elevation view of a preferred embodiment of the improved traffic signal 102 of the present invention employing the electric lamp 100 as shown in FIG. 1A. It will be clear to those skilled in the art that while drivers and pedestrians facing a traffic signal from the side, as shown in FIG. 1C, may have no line of sight to the lighted colored light 108 that happens to be lit at the time. In the present invention, drivers or pedestrians or other road or conveyor traffic will have clear view of the peripheral lamp portion 100 which would also indicate the color of the individual traffic light 108 which is lit.

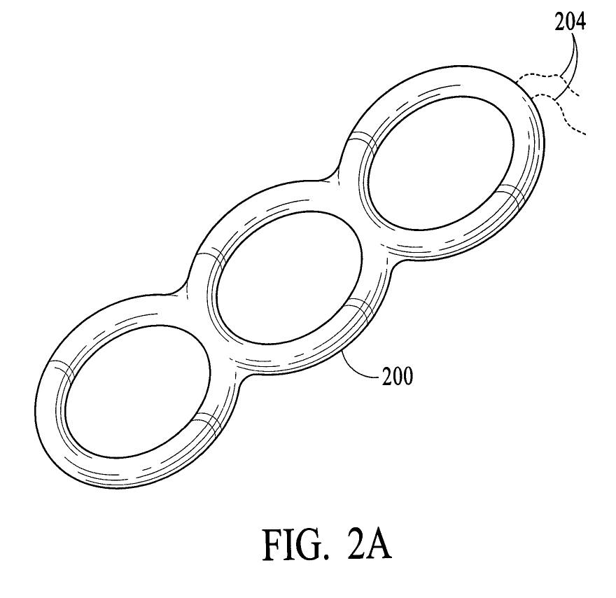

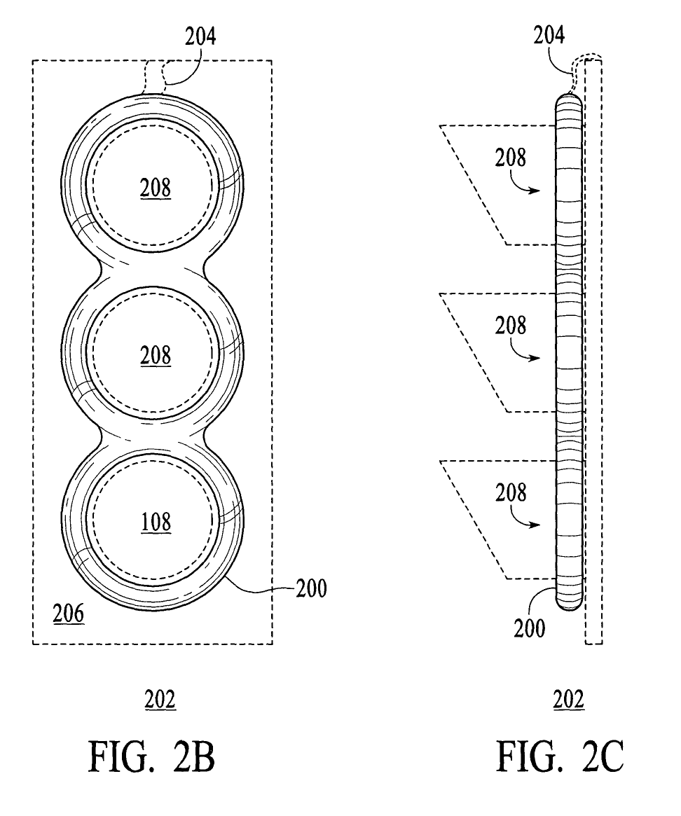

FIG. 2A is a representative perspective view of another preferred embodiment of an electric lamp 200 for use with the improved traffic signal (shown in subsequent drawings) of the present invention. A particular design for electric lamp 200 is described more fully in U.S. Application Serial No. 29/126,805 filed Jul. 25, 2000, now U.S. D440329 issued Apr. 10, 2001 entitled ELECTRIC LAMP, which is hereby fully incorporated herein, in its entirety. It will be understood that the triple ring lamp 200 can be essentially any shape essentially having 2 or 3 or 4 or more circular or oval portions or otherwise, having various ratios of length to width, etc. Electrical leads or contacts 204 are shown as extending wires. It will be understood that these electrical contacts can be different sizes and shapes also, including contact points, extending clips, extending prongs, using socket or plug-type adapters directly on the lamp surface, or connected to wiring or a wiring harness.

Again, it will be understood that the electric lamp 200 can be made of any suitable and appropriate lamp or lighting source or means available. These will include, but are not limited to, neon tubing, flexible light rope, fiber optic cables or bundles, imbedded individual or continuous LED or LCD lights, printed lighting circuit. The electrical source is alternating current (AC) or direct current (DC), and be high or low voltage. The light should be constant or pulsed, flashing or sequenced in any particular or desired programmed or programmable sequence. It will be understood that essentially any light source which can be configured into the essentially triple ring shape shown in FIG. 2A or other shape can be used.

FIG. 2B is a representative front elevation view of a preferred embodiment of the improved traffic signal 202 of the present invention employing the electric lamp 200 as shown in FIG. 2A. FIG. 2C is a representative side elevation view of a preferred embodiment of the improved traffic signal 202 of the present invention employing the electric lamp 200 as shown in FIG. 2A. It will be noted that the peripheral lamps 100 and 200 as shown and described herein as well as the traffic signal assemblies 102 and 202 are similar but different in their utility and function, design and range of visibility, method of manufacturing, etc. In any event, the traffic signal 202 of the present invention comprises, in addition to other features, as may be desired, a housing or body portion 206 and individual colored changing lights 208.

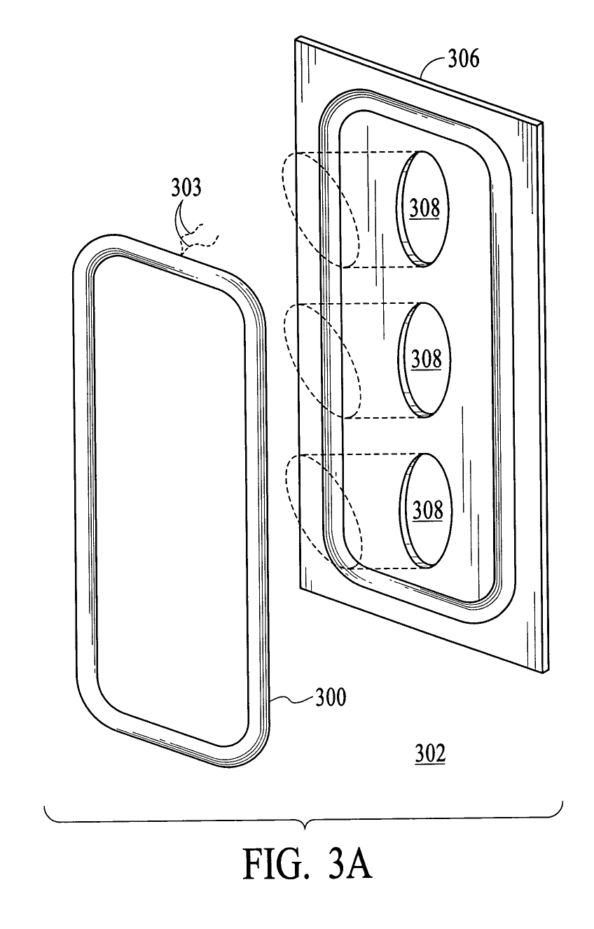

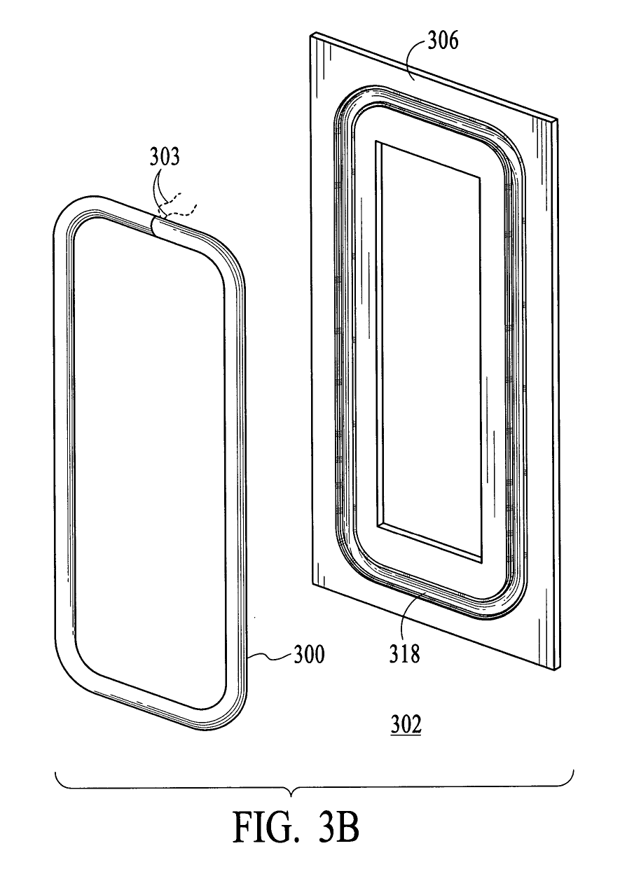

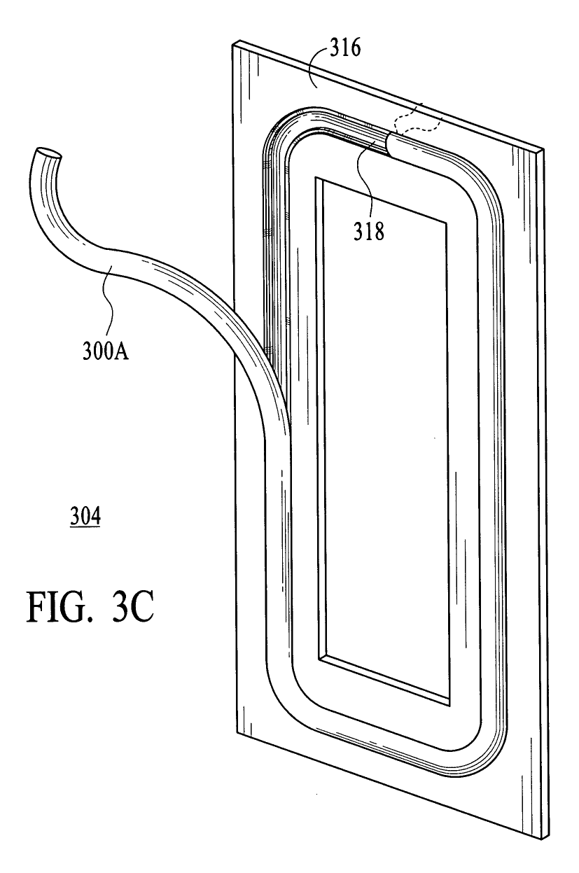

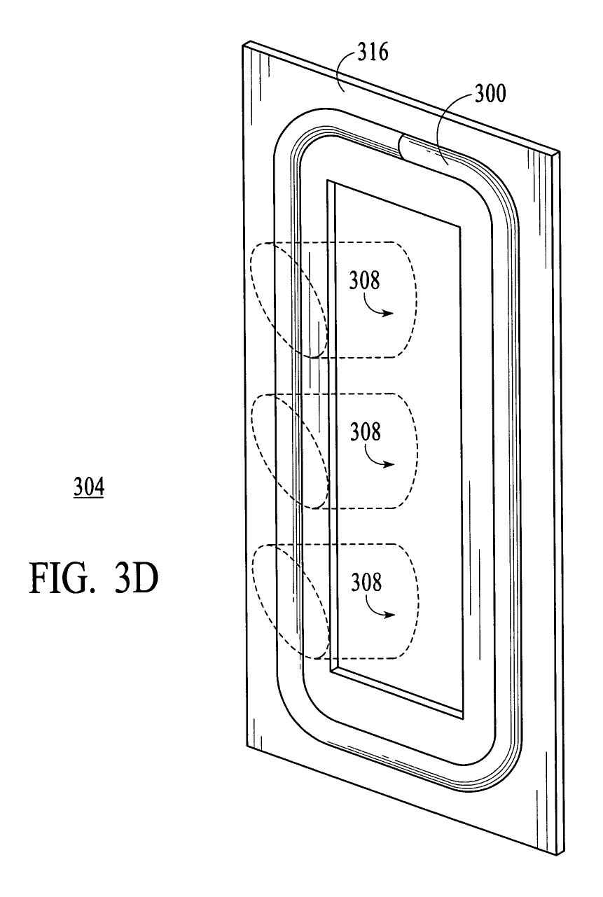

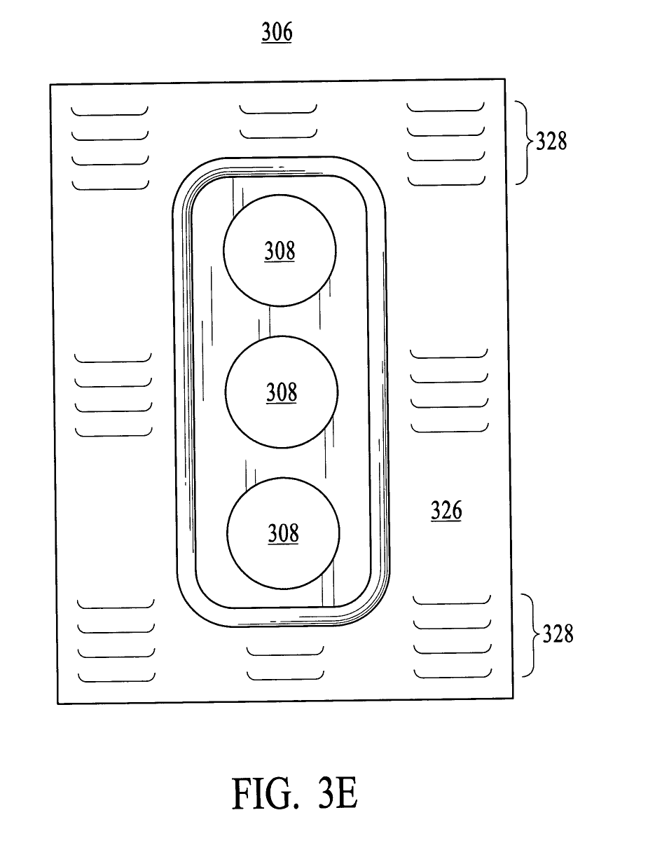

FIG. 3A is a representative front perspective view of another preferred embodiment of the improved traffic signal 302 of the present invention employing electric lamp 300. A particular design for electric lamp 300 is described more fully in U.S. Application Serial No. 29/138,318 filed Mar. 9, 2001, now U.S. D455365 issued Apr. 9, 2002 entitled ELECTRIC LAMP, which is hereby fully incorporated herein, in its entirety. In this embodiment, the lamp 300 has an essentially rectangular shape. As with the lamps 100 and 200, electrical leads or contacts 303 provide a source of power, control signal, color selection, sequence or timing, etc. A body or housing 305 is also shown, having a defined or integral front plate or front face. Individual changing lights 308 indicate to drivers of vehicles and pedestrians, etc., when it is safe to cross the street. As in the embodiments shown in FIGS. 1A-2C, the peripheral lamp 300 provides greater visibility to the selected light 308 when the peripheral lamp 300 is lit in conjunction therewith, in the associated or other red, yellow or green color.

FIG. 3B is a representative front perspective view of a preferred embodiment of the improved traffic signal retrofit assembly 304 of the present invention employing an electric lamp 300. In this assembly 304, a face plate 316 serves as a mounting plate for the lamp portion 300. A groove or setting 318 is located on the outside face of the face plate 316. This assembly 304 can be utilized in conjunction with an upgrade or retrofit kit for a conventional or custom traffic signal.

FIG. 3C is a representative front perspective view of a preferred embodiment of the improved traffic signal retrofit assembly 304 as shown in FIG. 3B employing an alternate electric lamp 300A. In this embodiment, the lamp portion 300A is a flexible, light rope or similar type of tubing which contains a light means.

FIG. 3D is a representative front perspective view of a method of use of a preferred embodiment of the improved traffic signal retrofit assembly 304 of the present invention employing an electric lamp 300. Thus, it will be understood that the light assembly 304 and others of the present invention comprise various components which can be utilized as retrofit kits or adaptors. This is shown in FIG. 3D.

FIG. 3E is a representative front perspective view of another preferred embodiment of the improved traffic signal retrofit assembly 306 of the present invention employing an electric lamp 300. In this embodiment, a back plate 326 is coupled to a traffic signal system 306. The back plate 326 has wind vents 328 therethrough so as to provide less resistance and strain against the mountings in high winds and rain situations. This face plate 326 can have any of other various geometries and configurations such as to enable it to fit onto standard, custom, and other commercial traffic signal or traffic light products, etc. As shown, the individual colored lights 308 which change colors as an indication of instructions to drivers or pedestrians may not be visible from the side, but the external peripheral rectangular shaped lamp portion 300 increases the visibility of the traffic signal assembly 306.

Thus, it will be understood that the outer peripheral lit lamp portions can be made of any color illuminated material or have lighting elements which each create separate colors. Light rope materials or other elongated lighting apparatus or technology used is incorporated within the scope of the present invention. The most important color which is used is red, since this is the universal STOP color. In this embodiment, therefore, the outer peripheral lamp portion only needs to have illumination capability in a single color, i.e., red. The outer am portion which is central in the novel and unique aspects of the present is not illuminated if the traffic signal is green or red. However, when the traffic light turns red, then the outer lamp portion turns red also, thus enhancing the luminosity and visibility of the red light. In any event, it would also be possible to configure a controller for the enhanced traffic signal of the present invention in which the color of the outer peripheral lighted lamp portion changes according to and synchronized with the main colored signal indicator for the traffic signal, i.e., green, yellow or red.

It will be understood that all of the enhancing lamps 100, 200 and 300 and those disclosed herein, regardless of shape and/or size, can be red, yellow, or green. They can also be made having different colors. Thus, it will become apparent that the present invention converts a traffic signal whose regular lights 108 red, yellow and green are not visible from the side, to a traffic signal 102, 202 and 302 which is visible from directly in front, from the side, etc.

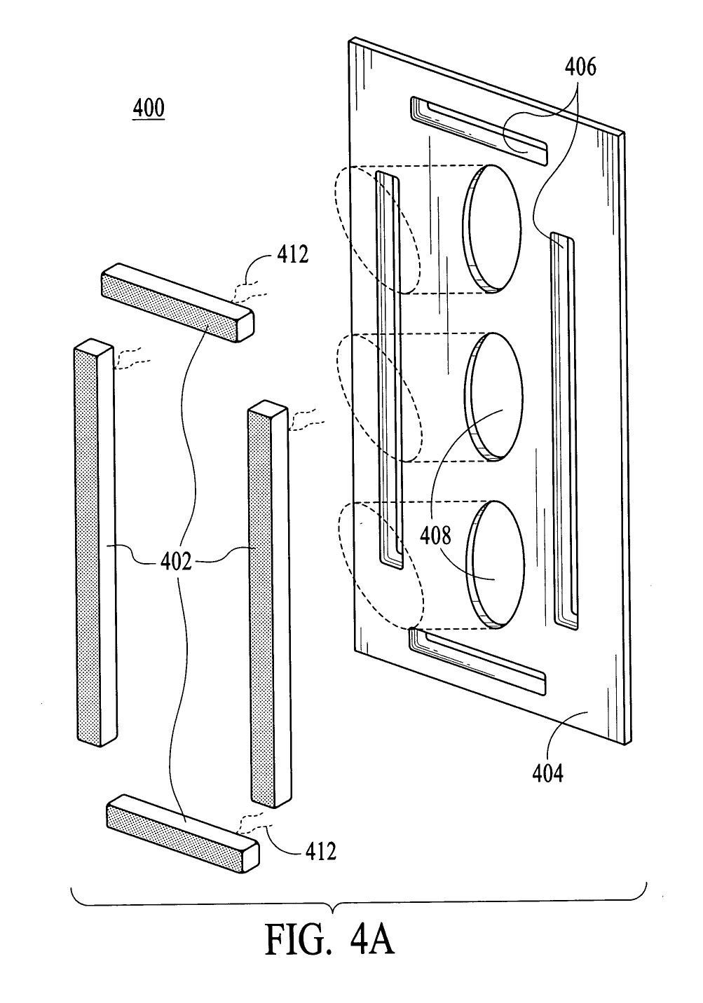

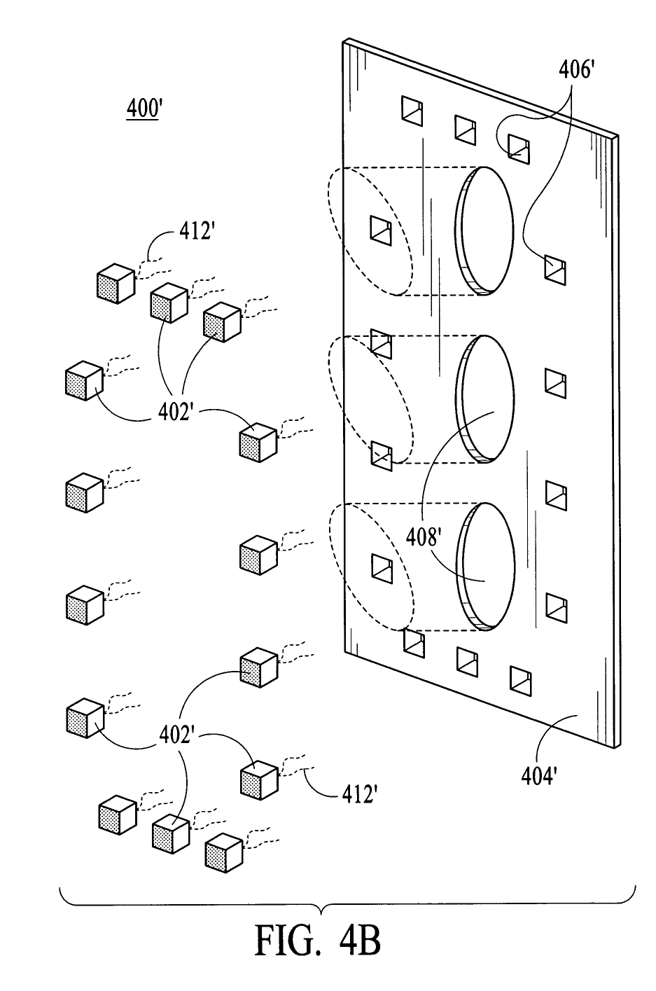

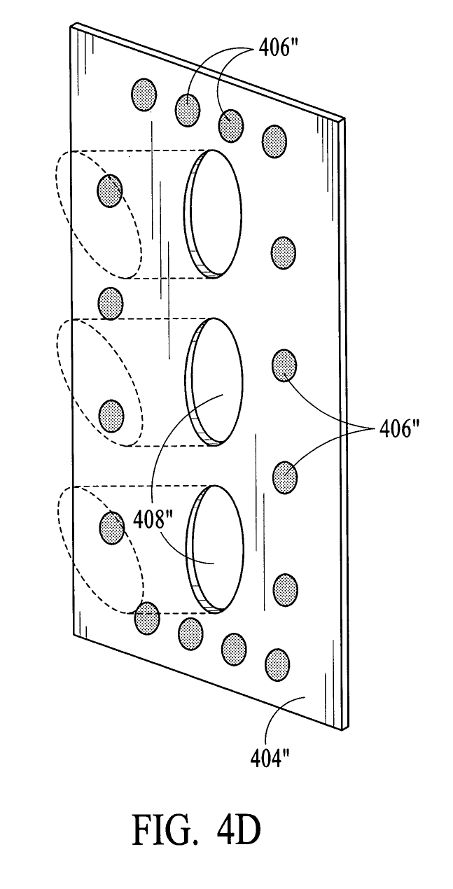

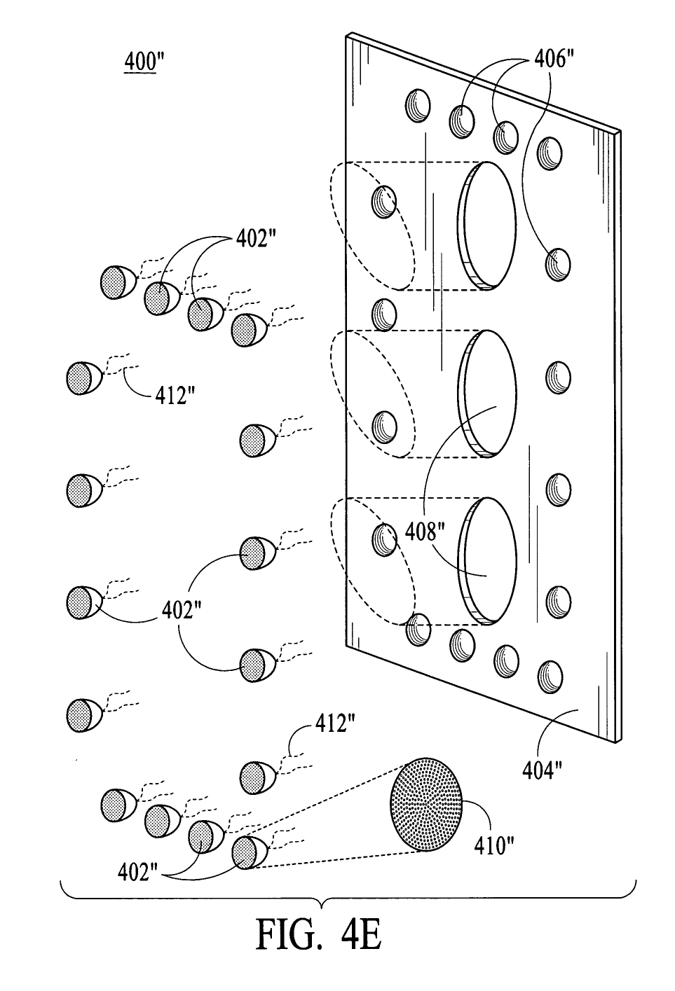

FIG. 4A is a representative front perspective, exploded view of a preferred embodiment of the improved traffic signal assembly 400 of the present invention employing peripheral auxiliary electric lamp portion 402. FIG. 4B is a representative front perspective, exploded view of a preferred embodiment of the improved traffic signal assembly 400′ of the present invention employing peripheral auxiliary electric lamp portion 402′. FIG. 4C is a representative front perspective, exploded view of a preferred embodiment of the improved traffic signal assembly 400′ of the present invention employing peripheral auxiliary electric lamp portion 402′. FIG. 4D is a representative front perspective, exploded view of a preferred embodiment of the improved traffic signal assembly face plate portion 404″ of the present invention having discrete locations 406″ for employing peripheral auxiliary electric lamp portion 402″ (not shown). FIG. 4E is a representative front perspective, exploded view of a preferred embodiment of the improved traffic signal assembly 400″ of the present invention employing peripheral auxiliary electric lamp portion 402″.

As described above with reference to the preferred embodiments, the preferred embodiments of FIGS. 4A-E comprise electric lamp traffic signal assemblies 400, 400′, and 400″, respectively. In the preferred embodiments, the assemblies 400, 400′, and 400″ comprise an auxiliary, peripheral electric lamp portions 402, 402′, and 402″, respectively. The auxiliary, peripheral electric lamp portions 402, 402′, and 402″ are mounted onto, or imbedded within, face plates 404, 404′, and 404″, and sunk into holes or sockets 406, 406′, and 406″. The actual changing color, indicator lights (not shown) of the traffic signal assemblies 400, 400′, and 400″ are mounted in back of, within body portions (not shown) or onto the face plates 404, 404′, and 404″, and shine through at the familiar indicator light positions 408, 408′, and 408″. It will be understood that the traffic signal assemblies 400, 400′, and 400″ can also be mounted in horizontal or angled orientations, with the actual changing color, indicator lights shining and visible through at the said indicator light positions 408, 408′, and 408″.

In preferred embodiments, the auxiliary, peripheral electric lamp portions 402, 402′, and 402″ comprise individual, two or more or clusters of LEDs, LCD, CFLs, CCFLs, or other type of electric lamps. As described above, auxiliary, peripheral electric lamp portions 402, 402′, and 402″ can be mounted onto the face plates 404, 404′, and 404″, and can be raised off the face plates 404, 404′, and 404″ by rails, brackets, mounting clips or other mechanical attachment or secure or securing/attachment means. An electrical wiring harness 412, 412′, and 412″ extends from a position on the individual auxiliary, peripheral electric lamp portions 402, 402′, and 402″ components, for coupling to the power source and controllers, etc.

In a preferred embodiment, a controller for the enhanced traffic signal of the present invention, including electric lamp traffic signal assemblies 400, 400′, and 400″ causes the color of the outer peripheral lighted lamp portions 402, 402′, and 402″ to change according to and synchronized with the main colored signal indicator lights at positions 408, 408′, and 408″, i.e., green, yellow or red.

A preferred apparatus and method for controlling the enhanced traffic signal of the present invention, including electric lamp traffic signal assemblies 400, 400′, and 400″, includes synchronized illumination of one or more outer peripheral lamp portions 402, 402′, and 402″ with illumination of the main red, green and yellow signal indicator lights at positions 408, 408′, and 408″. The method includes synchronized illumination of the outer peripheral red, green and yellow lamp portions 402, 402′, and 402″ with the main red, green and yellow signal indicator lights at positions 408, 408′, and 408″.

Another preferred apparatus and method for controlling a traffic signal includes illumination of the auxiliary, outer peripheral red colored lamp portions synchronized to the main red signal indicator light for the traffic signal. The method includes illumination of the outer peripheral red lamp portions simultaneously with the main red signal indicator light for the traffic signal.

Yet another preferred apparatus and method for controlling a traffic signal includes simultaneous illumination of one or more outer peripheral red colored lamp portions and the main red signal indicator light.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

1 A traffic signal assembly having greater visibility, the traffic signal assembly comprising:
a main body portion;
a plurality of main colored indicator control lights on at least one face of the main body portion;
one or more peripheral auxiliary lamp portions mounted on the at least one face of the main body portion and disposed essentially symmetrically, immediately around the plurality of main colored indicator control lights;
and a controller for controlling illumination of both the plurality of main colored indicator control lights and the one or more peripheral auxiliary lamp portions.

2 The traffic signal of claim 1 in which the one or more peripheral auxiliary lamp portions are disposed on a backplate portion and extend through openings on the at least one face of the main body housing.

3 The traffic signal of claim 1 in which the one or more peripheral auxiliary lamp portions comprise one or more LEDs, LCDs, CFLs or CCFLs.

4 The traffic signal of claim 1 in which the one or more peripheral auxiliary lamp portions comprise clusters of LEDs, LCDs, CFLs or CCFLs.

5 The traffic signal of claim 1 in which the one or more peripheral auxiliary lamp portions comprise a plurality of LEDs, LCDs, CFLs or CCFLs.

6 A controller for the enhanced traffic signal of the present invention in which the color of the outer peripheral lighted lamp portion changes according to and synchronized with the main colored signal indicator for the traffic signal, i.e., green, yellow or red.

7 A method for controlling a traffic signal in which one or more outer peripheral lamp portions are illuminated in synchronization with illumination of the main red, green and yellow signal indicator lights for the traffic signal.

8 The method of claim 7 in which one or more outer peripheral red, green and yellow lamp portions are illuminated in synchronization with illumination of the main red, green and yellow signal indicator light for the traffic signal.

9 A method for controlling a traffic signal in which one or more outer peripheral red lamp portions are illuminated in synchronization with illumination of the main red signal indicator light for the traffic signal.

10 The method of claim 9 in which the outer peripheral red lamp portions are illuminated simultaneously with the main red signal indicator light for the traffic signal.

11 A method for controlling a traffic signal in which one or more outer peripheral red lamp portions and the main red signal indicator light are illuminated simultaneously.
